(19) United States
(12) Patent Application Publication
(10) Pub. No.: US 2005/0055294 A1
(43) Pub. Date: Mar. 10, 2005

(54) Data processing system for implementing a financial market

(76) Inventor: Jean-Pierre Mustier, London (GB)

Correspondence Address: NEEDLE & ROSENBERG, P.C., SUITE 1000, 999 PEACHTREE STREET, ATLANTA, GA, 30309-3915, US

(21) Appl. No.: 10/487,474

(22) PCT Filed: Sep. 20, 2001
(86) PCT No.: PCT/GB01/04232

(30) Foreign Application Priority Data
Aug. 22, 2001 (GB) 0120426.2

(51) Int. Cl. G06F 17/60

(52) U.S. Cl. 705/35

(57) ABSTRACT

The disclosure relates to the field of banking and finance, and in particular relates to the implementation of a novel mechanism for providing pricing for financial products or transactions. There is provided a computer based data processing system for implementing a financial market, which permits customers to obtain prices for financial products from a range of banks, with some of which the customer has no normal trading relationship, in order to obtain optimum liquidity prices for the products.

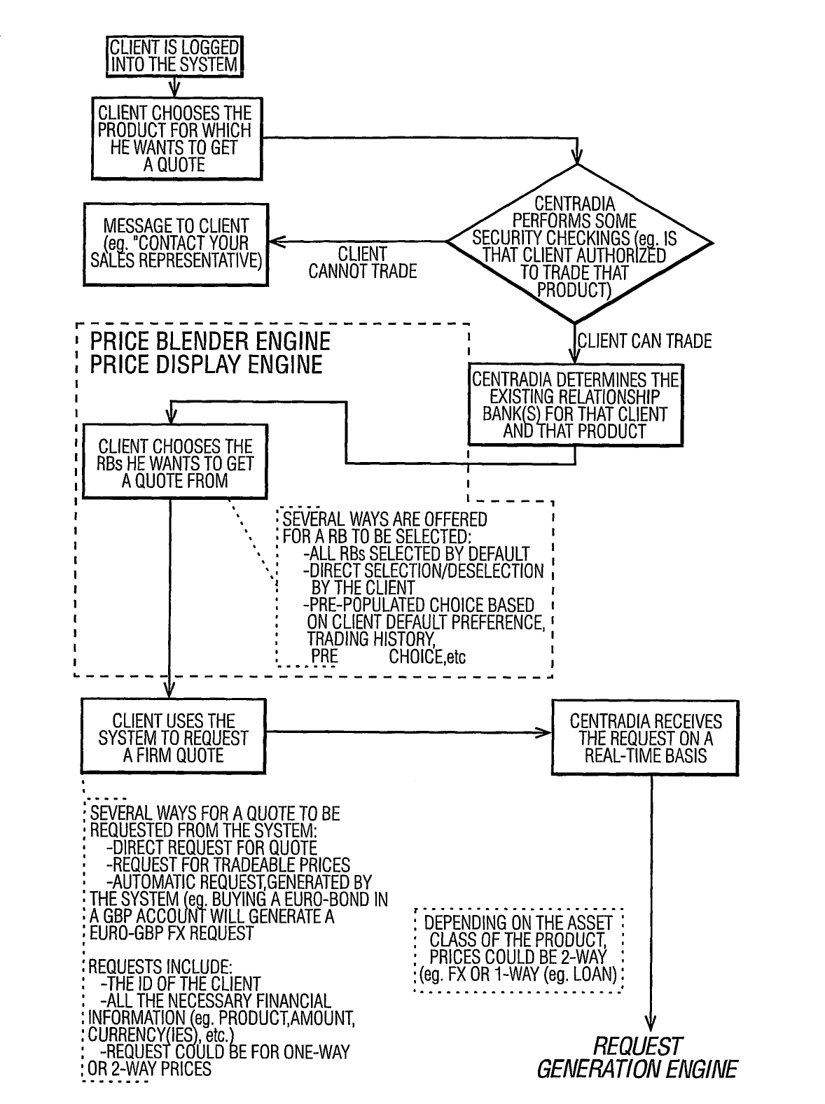

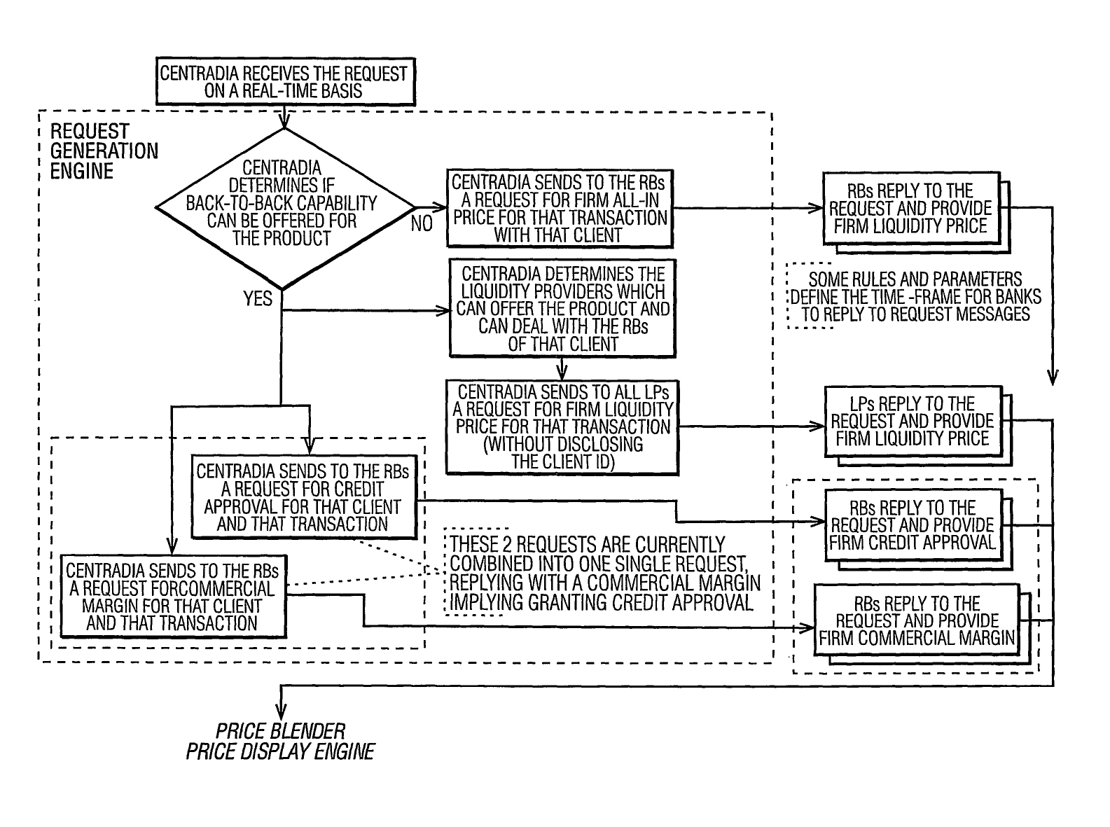

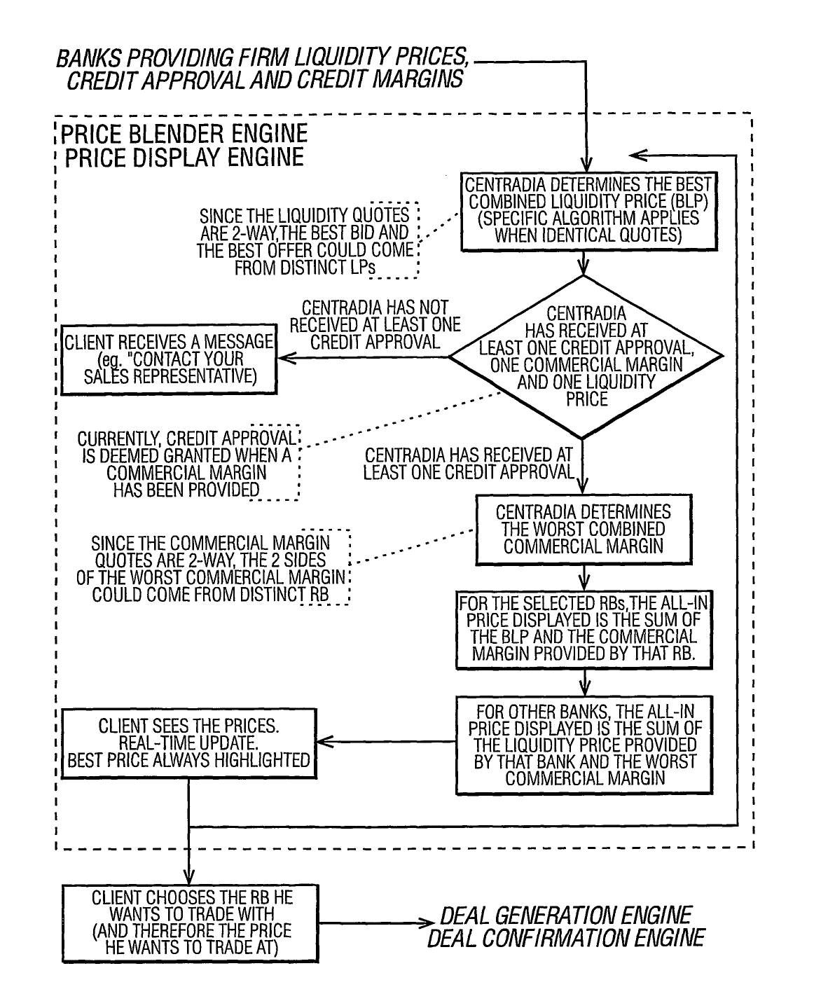

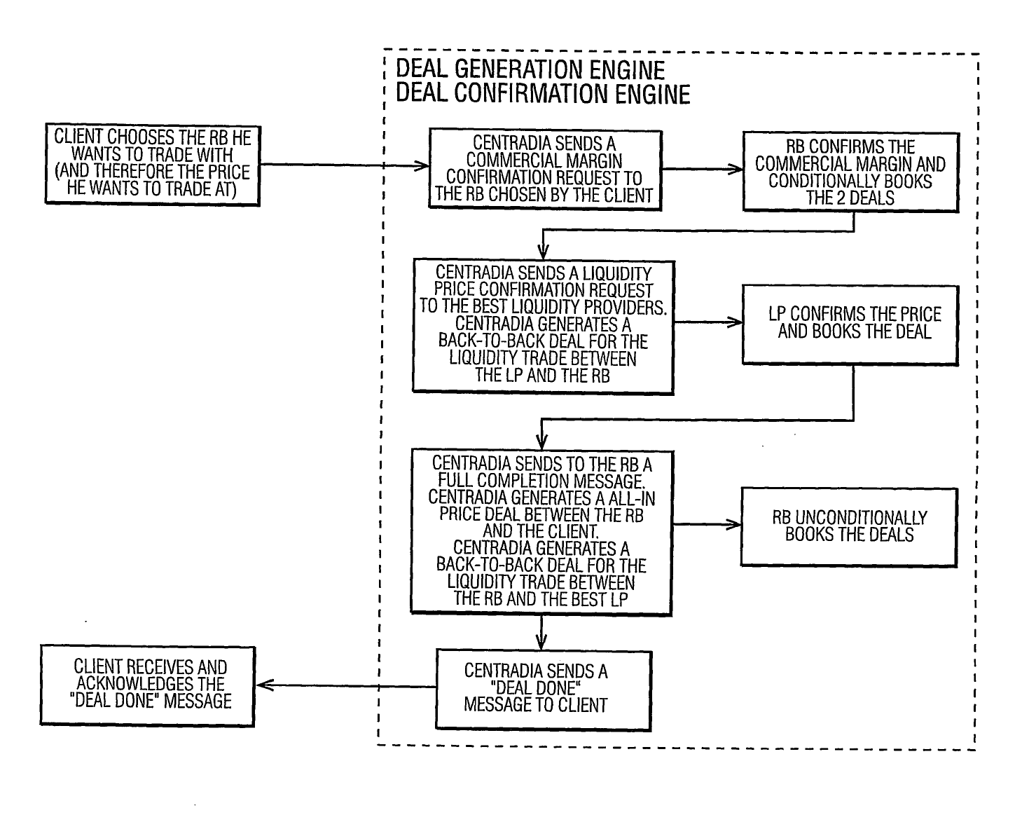

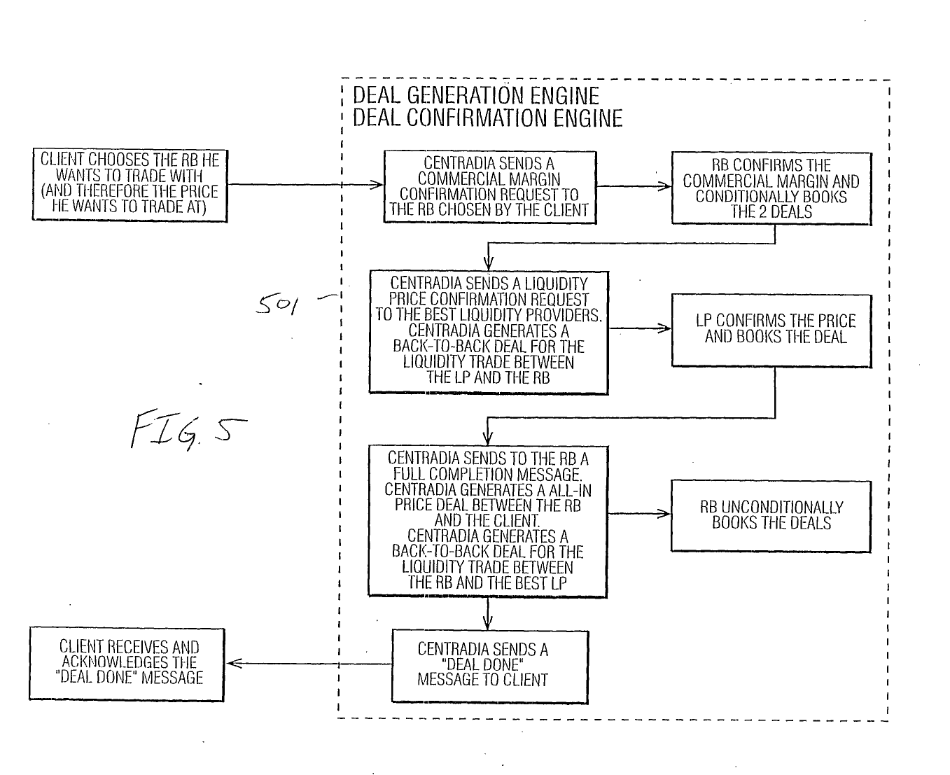

The present invention relates to the field of banking and finance, and in particular relates to the implementation of a novel mechanism for providing pricing for financial products or transactions.

Banks have trading relationships with their merchant banking customers in the financial markets. The relationship is based upon business considerations and credit limits which ensure that trades which take place do not exceed amounts for which credit approval exists, and for which clearing procedures are in place to ensure that executed trades are reconciled. The relationship may also be subject to certain regulatory constraints.

When a customer wishes to buy a financial product or execute a trade, the customer contacts a bank with which a trading relationship exists. For many financial instruments, the price offered will be a sum of the liquidity price, which represents market risk, and the margin. By “margin” we mean an adjustment applied to the liquidity price to reflect certain risks involved in making the transaction and a commercial profit for taking those risks. Thus the margin may include, for example, the credit risk, the cost of using bank capital, and the sales credit which reflects the commercial profit to be made on the transaction.

When a price is requested by a customer, it is usual for the bank to seek internal credit approval for the transaction with reference to a recorded credit limit for the customer. So long as the limit is not exceeded by the customer and the bank wants to make the deal, the transaction is approved.

Before a trade is executed, the customer may contact several of its relationship banks, in order to obtain the best price.

However, because of the practical constraints of the market, the customer is limited in the range of banks from which a price may be obtained. The present inventors have recognised that there would be market demand for a system which allowed prices to be obtained from a range of banks within a short time frame, even those with which the customer does not have a trading relationship, and cannot therefore usually trade. The present invention enables the operation of such a system.

According to the present invention there is provided a computer based data processing system for implementing a financial market, which system comprises:
a hub data processing system for administering a financial market in financial products provided to customers by a plurality of banks,
means for permitting access by customers to the financial market by data communication with the hub,
a plurality of satellite data processing systems in data communication with the hub, each satellite unit being associated with a bank providing: credit approval for transactions, margins for transactions, and financial products to be the subject of the transactions, thereby permitting access of the financial products of the banks to the financial market, and wherein the hub is provided with software which implements the following features,
a database of bank identifiers, each identifier being associated with a satellite bank,
a database of financial product identifiers, each of which financial products being offered by at least one, but preferably all, of the banks,
a database of customer identifiers, permitting identification of a customer accessing the hub, each customer identifier being associated with one or more relationship bank identifiers which identify the bank or banks with which a customer has a prearranged trading relationship and with whom the customer can therefore trade,
a database of liquidity provider identifiers, permitting identification of banks which are providers of liquidity quotes, each identifier being associated with one or more financial product identifiers which identify the financial product for which the liquidity provider can provide liquidity quotes and transactions,
means for initiating a request for a quote for executing a transaction involving one or more of the financial products,
means for communicating a liquidity price quote request for the transaction to each of the liquidity providers offering that financial product,
means for logging and updating each liquidity price quote for the requested financial transaction returned to the hub by each of the liquidity providers,
means for communicating a margin price request for the financial transaction to each of the relationship banks,
means for logging a margin price quote returned to the hub by each of the relationship banks,
means for calculating an array of composite quotes, each quote comprising the sum of (1) a liquidity price provided by one of the liquidity providers and (2) a margin quote provided by one of the relationship banks,
means for permitting selection by the user of a preferred composite quote from the array of quotes in order to generate an order command for executing the transaction at the selected composite price,
means for instructing execution of the transaction which will either be between (a) a relationship bank and the customer on the one hand, or (b) the liquidity provider, a relationship bank and the customer on the other hand, depending upon the particular composite quote chosen and whether the liquidity provider is also a relationship bank,
means for communicating to the customer that the transaction has been executed.

In the foregoing, a “relationship bank” is a bank, broker, market place or other party with which or through which a customer has a pre-existing trading relationship, satisfying regulatory requirements such as credit ratings and with which the customer is authorised to trade. Any reference to bank or relationship bank in this document should be construed accordingly.

A “liquidity provider” is a bank, broker, market place or other party which is capable of providing a liquidity price for a particular financial product required by a customer. This may include relationship banks, but does not necessarily include relationship banks. For example a relationship bank for a particular customer may not trade in certain financial products, and therefore may be unable to provide a liquidity price. Any reference to liquidity provider in this document should be construed accordingly.

Depending on the clients and on the financial product, a bank could be a liquidity provider, or a relationship bank, or both.

A key advantage of the present invention is that a customer is able to obtain a composite price based on the best liquidity price for a transaction, irrespective of whether the customer has a trading relationship with the liquidity provider providing the liquidity price. The composite price is selected on the basis of a liquidity price selected from all of the liquidity providers, rather than having to rely upon prices offered by the particular bank or banks with which the customer has a trading relationship.

The credit risk is taken by the relationship bank, who trades back to back with liquidity providers to obtain the best liquidity price for its customer. By back to back in this context, we mean that the relationship bank transfers the market risk of its trade with its customer to a liquidity provider. The relationship bank undertakes to accept the credit risk (since it has the trading relationship) and therefore applies a margin to the liquidity price.

In this way a customer can, in effect, trade with a bank with which the customer has no trading relationship, and therefore no normal mechanism permitting trading. Needless to say, it may be that the best liquidity price comes from the usual relationship bank (i.e. the preferred liquidity provider is the relationship bank), in which case the customer will trade as normal. In a preferred arrangement, the customer will not see, or be informed, from which liquidity provider the liquidity quote portion of the composite quote has come. In this way the customer will simply see a quote for the transaction which is provided by a relationship bank.

Frequently however, the best composite price (the all-in price seen by the customer) involves a liquidity price from a non-relationship bank, and in this case the customer is able to obtain a price for the transactions which would not otherwise be available.

In practice the system will in most circumstances include in the software: means for requesting credit approval from the relationship banks for the requested transaction, the credit approval/disapproval being made with reference to approval criteria for that customer held by the relationship bank. Preferably the system includes software means for logging an approve/disapprove decision, and means for excluding that relationship bank from the set of relationship banks providing a margin for the transaction in the event of disapproval. The bank may still be a liquidity provider.

The financial products which may usefully be traded using this invention are those for which it is usual to charge a liquidity price and a margin. In particular, these include, but are not limited to: Foreign Exchange Spot, Foreign Exchange forwards, Foreign Exchange swaps, Foreign Exchange Non-deliverable forward, Foreign Exchange options Interest Rate Derivatives.

In addition, various financial products may also be the subject of the present invention. These types of product include Money Market Loans, Money Market Deposits, Certificates of deposit, Commercial Paper, Fixed-Income—both primary markets (i.e. issuance) and secondary markets (i.e. trading).

The prices which are quoted by the banks to the customer may for certain products—in particular foreign exchange products—have a bid/offer spread applying to the liquidity price, and a distinct bid margin/offer margin. Hence there may be a bid composite price and an offer composite price. Both of these may be provided by the banks and displayed to the customer.

The banks involved will in practice each be linked with the hub by a secure data processing network. The banks will provide a range of financial products, in competition with one another.

A range of customers will subscribe to the service offered according to the present invention, and will be able to log-on to the secure network in order to take part in the financial market. Access to the market will typically be by means of an Internet link, via each customer's web browser, with a website interface provided for communication with the hub. Encryption technology may be used to ensure a secure data link between the customer and hub. This is not described further herein as suitable technology is well known in the art.

Each customer must have a trading relationship with at least one of the competing banks. It is normal for customers only to have trading relationships with a narrow range of banks, for credit approval reasons. These are the relationship banks.

The relationship banks will charge the customer a margin to pay, for example, for the counter-party (i.e. credit) risk of trading with the customer. This margin goes on top of the trading liquidity prices that are quoted. Although many customers will have just one relationship bank, there will be many customers who will have more than one and some who have relationships with all member banks.

The present invention provides subscribers with the ability to benefit from the best liquidity price from all of the member banks, even if only a subset of the banks (the “relationship banks”) will be able to trade directly with them.

Therefore, in order that customers can benefit from a better liquidity price from another liquidity provider, the system will automatically generate an internal deal (a “back-to-back” transaction) between the selected relationship bank and the member bank which is the provider of the best price (the “liquidity” provider). The relationship bank therefore automatically off-loads the market risk to another bank if its price is better, and keeps the client risk.

Typically, the final price(s) shown to the customer will be a composite price composed of the best liquidity price(s)+the margin: this will constitute the ‘all-in’ price and will only be displayed in this format to the customer.

Preferably, when the customer requests a price, a message will be sent to the relationship bank or banks requesting a credit approval and margin for that transaction. At the same time, a message will be sent to all banks requesting the liquidity price. These messages are to be responded to by the banks within a pre-approved time. Having received the quotes, a software pricing engine will blend margin and liquidity prices to give the all-in composite price or prices to the customer.

It will be evident from the foregoing that the presented invention may be implemented in several ways, one of which involves a price quote being generated in response to a particular request for a quote in which the customer specifies the parameters of the request and the hub returns one or more quotes, and the customer selects one of these to make the transaction.

Another involves the real-time provision of a “tradable price” to the customers for one or more financial products which the system is capable of trading. The prices are updated periodically in order to take into account variations in the liquidity prices and margins which may occur from time to time. The updating may be automatic, in response to an automatic request for a quote distributed by the hub system to the satellite systems, or carried out in response to updated pricing information provided un-prompted by one or more of the satellite systems.

In practice the invention may provide a mixture of “real-time” (i.e. tradable) and “on request” prices, depending upon the requirements of the customer, satellite banks and the suitability of the financial product for these mechanisms. Hence some prices may be quoted in real-time, while others are only available in response to a request.

In a particular embodiment of the invention, the system is provided with software which permits a direct trading option, in which the system only shows to a customer liquidity price/margin composite prices which are derived from one or more relationship banks for that customer. In other words, the possibility of trading indirectly with the non-relationship banks is removed.

In another embodiment of the invention, the system is provided with software which ensures that a customer is provided with a best price which comprises a composite of the best liquidity price provided by all of the liquidity providers, plus the lowest margin provided by a relationship bank. Preferably the customer is also provided with a comparison price, which in order to encourage execution of a transaction involving the best price, is a sub-optimal price such as a combination of the worst relationship bank margin and the worst liquidity price.

In one embodiment the comparison price is a composite of a liquidity price provided by a non-relationship bank and the worst margin of the relationship banks

In another embodiment of the invention, the software allows each customer to select, or de-select, certain banks as its preferred relationship banks or liquidity providers.

Real Time Pricing

In carrying out this aspect of the invention the system will collate the real time liquidity prices from each of the banks and add the relationship bank's customer margin to each of the prices, providing him/her with a real-time moving window of the best ‘all-in’ (liquidity plus margin) prices. The customer may typically have a buy/sell button on the screen allowing him/her to transact as the prices move.

In a preferred aspect of the invention, the real-time tradable screen could be made available for the currency markets, trading specific currencies (or currency pairs). The prices shown could be limited to a specified (per product) minimum and maximum Euro equivalent trade amounts. Beneficially, this will facilitate the provision of a service for exchanging or trading amounts of foreign currency.

As used herein, the term “Bank” is intended to be construed broadly to cover any financial institution, broker, market place or other party which offers financial products to customers. The following is a description by way of example only, and with reference to the accompanying drawing, of one way of carrying out the present invention. Other methods will be evident to the person skilled in the art.

1. Request for Liquidity Price

A customer will request a price for a specific detailed transaction, the system will send a request for the liquidity price for that transaction to each of the liquidity providers or, optionally, only to the relationship banks. Upon receiving the liquidity providers' liquidity price quotes, the system will then collate the liquidity prices.

2. Request for Margin

As the customer requests a price, the hub processor will send a request for a margin quote to the bank(s) with which the customer has a credit relationship (the relationship banks), in addition to the liquidity price request sent to all the liquidity providers.

3. Credit Approval

At the same time that the customer requests a price the hub processor sends a message to the relationship bank or banks requesting a credit approval decision for that customer. If the transaction will involve the customer exceeding the credit that the relationship bank has available for the customer, the bank will send a message that means that no price will be given for trading with that bank. If, however, the customer has enough credit available with the bank or banks, a credit approval message will be returned to the hub processor platform to confirm that the customer can trade on that specific product for that specific amount. It may be that an active request for—or the active provision of—credit approval is not necessary, as the mere act of providing a price or margin may be regarded as implicit approval. Conversely, if a margin is withheld, then this may be due to disapproval.

4. Price Blending

The hub processing system will then provide to the customer a list of the blended ‘all-in’ (liquidity plus margin) prices received, allowing it to trade with one of its chosen “relationship banks” but taking advantage of the best liquidity price. Where the relationship bank does not itself offer the best liquidity price, the relationship bank can still offer the customer this best liquidity price by means of an back-to-back trade automatically generated by the system when a trade is confirmed by the customer. The customer confirms the trade by pressing a submit button (or similar) on its computer or screen.

5. Direct Trading

The member banks of the system may chose not to provide the back-to-back trading facility for certain financial products. Hence the system of the invention may provide customers with the ability to request quotes solely from their relationship banks. In these circumstances, when the customer asks for a price, the system will send the details of the transaction to the customer's relationship bank or banks for pricing.

A more specific embodiment is described with reference to the drawings, which represent an annotated flow chart illustrating the steps involved in conducting a trade between a customer and member banks by a system according to the present invention. The system of the invention is designated “Centradia” in the drawings.

This specific embodiment will in practice be carried out by computer software written to carry out the functional steps required. No specific details of the code required to implement the system are given, as the production of suitable coding required to implement the steps described will be routine to the person skilled in the art of programming for financial trading applications.

Steps involved in a typical embodiment of the invention:
A group of, for example, five banks form a network in data communication hub processing unit for administering the system. The banks decide which financial products to offer on the system. Customers having a trading relationship and credit status with at least one of the member banks are able to access the hub system by means of dedicated or public (such as the Internet) communication system.
The customer logs on to the system via a secure connection through a network terminal which is in data communication with the hub (this network terminal could be a standard personal computer provided with a standard Internet browser). The user selects the product he wishes to trade and is presented with a transaction characterisation screen.
The user chooses the parameters for the trade, i.e. amount to be traded, details of the financial product.
The system will refer to its customer database and identify the banks with whom the customer has a trading relationship; the relationship banks.
The system hub will identify which of the banks are capable of providing a liquidity price for the product, either with reference to an on-board database, or by querying the banks themselves. The system collates the other required parameters for defining the trade, such as currencies, maturity period, etc.
The system hub sends request messages to the relevant banks for three items; the customer credit limit, the margin that the bank will apply if it has a trading relationship, and the liquidity price for the chosen transaction. It may arranged that the sending of a margin implies credit line approval. The relationship banks will be told the identity of the customer, while the non-relationship banks (acting as liquidity providers) will be asked for a quote for a “notional customer” without identifying the customer.

The banks must return a liquidity price to the system hub as soon as they are able (there is no need to wait for the margin) and within a pre-agreed time-frame.
The platform will collate and continuously calculate and update the best liquidity price as liquidity prices arrive from the banks.
The relationship banks' customer margins will be added to the best liquidity price to make a best all-in price, which is transmitted to the customer screen. For obvious reasons, the customer should not see the margin applied.
If there are equal liquidity prices from the banks, the hub system may be provided with an algorithm by which to choose the liquidity provider. This may simply involve the algorithm selecting the first liquidity price that is received by the platform. If the relationship bank has an equal best liquidity price, the algorithm may ensure that it wins the liquidity deal, regardless if it was the first to provide a quote.

In one embodiment, the all-in-one composite prices may be shown on the customer's screen as soon as they are collated by the hub system, provided that a relationship bank has provided a customer margin for the trade. In this way the customer may, in real time, view the updating prices. The amount of time before the price settles may be limited to a predetermined time from when the first price appears. The time period will be pre-defined within the hub system by reference to a database of selected financial product identifiers. This may be asset class specific (and dependent on other parameters such as currencies, maturity date etc.)

Needless to say it is essential for the present invention to be carried out that the member banks of the system have or are provided with a mechanism which allows bank-to-bank transfers as required to satisfy the requirements of back-to-back liquidity pricing and trading.

1. A computer based data processing system for implementing a financial market, which system comprises;
a hub data processing system for administering a financial market in financial products provided to customers by a plurality of banks,
means for permitting access by customers to the financial market by data communication with the hub,
a plurality of satellite data processing systems in data communication with the hub, each satellite unit being associated with a bank providing: credit approval for transactions, margins for transactions, and liquidity quotes for financial products to be the subject of the transactions, thereby permitting access of the financial products of the banks to the financial market, and wherein the hub is provided with software which implements the following features,
a database of bank identifiers, each identifier being associated with a satellite bank,
a database of financial product identifiers, each of which financial products is offered by at least one, but preferably all, of the banks,
a database of customer identifiers, permitting identification of a customer accessing the hub, each customer identifier being associated with one or more relationship bank identifiers which identify the bank or banks with which a customer has a prearranged trading relationship and with whom the customer can therefore trade,
a database of liquidity provider identifiers, permitting identification of banks which are providers of liquidity quotes, each identifier being associated with one or more financial product identifiers which identify the financial product for which the liquidity provider can provide liquidity quotes and transactions,
means for initiating a request for a quote for executing a transaction involving one or more of the financial products,
means for communicating a liquidity price quote request for the transaction to each of the liquidity providers offering that financial product,
means for logging each liquidity price quote for the requested financial transaction returned to the hub by each of the liquidity providers,
means for communicating a margin price request for the financial transaction to each of the relationship banks,
means for logging a margin price quote returned to the hub by each of the relationship banks,
means for calculating an array of composite quotes, each quote comprising the sum of (1) a liquidity price provided by one of the liquidity providers and (2) a margin quote provided by one of the relationship banks,
means for permitting selection by the user of a preferred composite quote from the array of quotes in order to generate an order command for executing the transaction at the selected composite price,
means for instructing execution of the transaction which will either be between (a) the relationship bank and the customer on the one hand, or (b) the liquidity provider bank, the relationship bank and the customer on the other hand, depending upon the particular composite quote chosen and whether the liquidity provider is also a relationship bank, thereby permitting the customer to have access to liquidity prices from banks other than those with which it has a trading relationship.
means for communicating to the customer that the transaction has been executed.

2. A system as claimed in claim 1 wherein the means for initiating a quote comprises means for logging a quote communicated to the hub by the customer.

3. A system as claimed in claim 1 wherein the means for initiating a quote comprises means for the automatic and periodic provision of a quote or quotes to a customer on the basis of a set of one or more financial products for which that customer has selected for real-time quoting.

4. A system as claimed in claim 1 wherein the software provides means for requesting credit approval for the transaction for which a quote has been requested, or made, from the relationship bank or banks.

5. A system as claimed in claim 4 wherein the software includes means for logging an credit approval/disapproval communication, and in the event of a disapproval communication the relationship bank concerned is excluded from the set of relationship banks providing margin quotes for that transaction.

6. A system as claimed in claim 1 wherein the means permitting access of the customers to data communication with the hub is an Internet link.

7. A system as claimed in claim 6 wherein the hub provides a website for presentation of information and receipt of trading instructions from customers.

8. A system as claimed in claim 1 wherein the hub system is provided with software which permits a direct trading mode, in which the system only shows to a customer liquidity price/margin composite prices which are derived from one or more relationship banks for that customer and not from non-relationship liquidity providers.

9. A system as claimed claim 1 wherein the hub system is provided with software which ensures that a customer is provided with a best price which comprises a composite of the best liquidity price provided by all of the liquidity providers, plus the lowest margin provided by a relationship bank.

10. A system as claimed in claim 9 wherein the customer is also provided with a comparison price list, which is a sub-optimal price on comparison with the best price.

11. A system as claimed in claim 10 wherein the comparison price list comprises a combination of the worst relationship bank margin and the worst liquidity price.

12. A system as claimed in claim 10 wherein the comparison price list comprises a composite of a liquidity price provided by a non-relationship bank and the worst margin of the relationship banks

13. A system as claimed in claim 1 wherein the financial products are one or more of: Money Market Loans, Money Market Deposits, Foreign Exchange Spot, Foreign Exchange forwards, Foreign Exchange swaps, Foreign Exchange Non-deliverable forward, Foreign Exchange options, Certificates of deposit, Commercial Paper, Interest Rate Derivatives, Fixed-Income Issuance, Secondary Fixed-Income.
